(19) United States
(12) Patent Application Publication
(10) Pub. No.: US 2005/0046393 A1
(43) Pub. Date: Mar. 3, 2005

(54) Battery charger

(76) Inventors: Toshiki Nakasho, Mihara-gun (JP); Eiji Satsuma, Sumoto-city (JP)

Correspondence Address: WENDEROTH, LIND & PONACK, L.L.P., 2033 K STREET N. W., SUITE 800, WASHINGTON, DC, 20006-1021, US

(21) Appl. No.: 10/925,982

(22) Filed: Aug. 26, 2004

(30) Foreign Application Priority Data
Aug. 29, 2003 (JP) 2003/306261

(51) Int. Cl. H02J 7/04

(52) U.S. Cl. 320/150

(57) ABSTRACT

The battery charger has a case provided with a battery pocket in which batteries can be loaded and unloaded. The battery charger is provided with temperature sensors which detect the temperature of batteries in the battery pocket, and with a charging circuit which detects battery temperature via the temperature sensors and controls charging current. Further, the battery charger is provided with thermal conducting units which press against the surfaces of batteries loaded in the battery pocket, and with spring structures which resiliently press the thermal conducting units against the surfaces of the batteries. Thermal conducting units are provided with thermal conducting plates and temperature sensors.

### BACKGROUND OF THE INVENTION

This invention relates to a battery charger which is provided with a temperature sensors to detect the temperature of a batteries being charged.

When a battery is charged, its temperature rises. In particular, battery temperature rises rapidly as full charge is approached. Battery temperature rise can be a cause of degradation in battery characteristics. To prevent battery performance degradation, battery chargers have been developed which are provided with temperature sensors to detect battery temperature, (Patent References 1 and 2).

[Patent Reference 1] Japanese Patent Application 2002-199609 (2002)

[Patent Reference 2] Japanese Patent Application HEI 5-30669 (1993)

In the battery charger disclosed in patent reference 1, a temperature sensor is inserted in soft tubing and placed in contact with a battery pack surface. This temperature sensor contacts a battery surface via the soft tubing and detects battery temperature. In the battery charger disclosed in patent reference 2, the temperature sensor is pushed out by a coil spring to thermally join with a heat conducting part. This temperature sensor detects battery temperature via the heat conducting part.

In battery chargers cited in these and other disclosures, a temperature sensor detects battery temperature, and for example, charging current is cut off when battery temperature greater than a specified temperature is detected. In battery chargers of this type, accurate detection, of battery temperature is difficult. Even when a temperature sensor is placed in direct contact with a battery, it cannot always detect temperature accurately. FIG. 1 is a structure investigated by the present applicant wherein a temperature sensor 4 provided with a temperature detection section 104A was pressed in direct contact with the surface of a battery 102. Even with this structure, the temperature sensor 104 could not accurately detect battery temperature because of the action of cool outside air flow in gaps between the battery 102 and the temperature sensor 104, as shown by the arrows of FIG. 1. FIG. 2 is another structure investigated by the present applicant. This structure absorbs battery 202 heat with a metal plate 35 and that absorbed heat is conducted to the temperature sensor 204. In the case where the battery is repeatedly inserted and removed for charging, gaps develop between the battery 202 and the metal plate 35 of this structure (not illustrated), and suitable measurement of battery 202 temperature becomes difficult. Although battery 202 heat can be conducted to the metal plate 35, the metal plate 35 is cooled by air flow, as shown by the arrows of FIG. 2. Therefore, even with these configurations, battery temperature cannot be accurately detected. As discussed, even when the temperature sensor is placed in direct contact with the battery, or even in a structure which contacts the battery with metal plates, battery temperature cannot be accurately detected in addition, it is even moire difficult to accurately detect battery temperature in real-time with no time delay. Time delays in detection can be corrected to some degree by revising detected temperatures via a micro-computer housed in the battery charger. However, high accuracy micro-computer correction cannot be performed with respect to rapid temperature rise at the end of charging, or with respects to variation in the temperature environment due to repeated charging. This is because the temperature sensor and battery temperature curve do show the same behavior, and the temperature sensor becomes unable to follow the rapid battery temperature variations. When temperature gradients become large, the difference between temperature detected by the temperature sensor and battery temperature gradually increases, and accurate battery temperature detection becomes even more difficult.

A battery charger, with a battery protection function in a circuit that detects battery temperature, does not require temperature detection with a great deal of precision. However, it is important to detect battery temperature with extremely high precision in a battery charger which detects battery temperature, regulates average charging current according to battery temperature, and controls average charging current to consistently maintain battery temperature at a constant value.

In addition, the structure shown FIGS. 3 and 4 has been adopted as a configuration for detecting the temperature of a charging battery in battery chargers on the market. In this structure, the bottom surface 33 of a battery pocket 32 provided in the case 31 is shaped to conform to the shape of circular cylindrical batteries 302, and a temperature sensor 304 is disposed under the surface of a peak region in that bottom surface 33. The temperature sensor 304 is fit inside a cavity 34 provided under the surface of the peak region of the bottom surface 33. In this configuration, battery 302 heat is conducted to the temperature sensor 304 by routes indicated by the arrows in FIG. 4. Thermal conduction paths are as follows.

(1) thermal conduction in the battery itself

(2) thermal conduction from the battery to an air layer to the, case

(3) thermal conduction in the case

(4) thermal conduction from the case to an air layer to the temperature sensor

In this structure, since thermal conduction paths from the battery to the temperature sensor are long, and the bottom surface of the case is cooled by air, the difference between battery and temperature sensor temperature becomes large. Further, when battery temperature rises, the time from the temperature sensor to reach the same temperature increases, and the drawback that battery temperature cannot be accurately detected without a time delay cannot be resolved.

### SUMMARY OF THE INVENTION

The present invention was developed to resolve these types of drawbacks. Thus it is an important object of the present invention to provide a battery charger which has temperature sensor and can detect battery temperature with high precision and reduced time delay to allow battery charging under ideal temperature conditions.

The above and further objects and features of the invention will be more fully apparent from the following detailed description with the accompanying drawings.

The battery charger of the present invention is provided with a battery pocket in a case for mounting batteries in manner allowing loading and unloading for charging. The battery charger is also provided with temperature sensors to detect the temperature of batteries loaded in the battery pocket and a charging circuit to control charging current. Further, the battery charger is provided with thermal conducting units which press against the surfaces of batteries loaded in the battery pocket, and spring structures which elastically. press thermal conducting units against the battery surfaces. A thermal conducting unit is provided with a thermal conducting plate and a temperature sensor.

In the battery charger of the present, intention, batteries can be circular cylindrical single cell batteries, and the section of a thermal conducting until that presses against the battery can be shaped to follow the circular cylindrical contour of the battery. Further, temperature sensors can be disposed between batteries and thermal conducting plates in the battery charger of the present invention.

The charging circuit can control average charging current to keep battery temperature at a holding temperature, and batteries cart be charged while maintaining battery temperature at the holding temperature.

A thermal conducting plate can be a single, thin folded mental plate capable of elastic deformation, and the spring structures and thermal conducting plate can be configured as one piece of metal plate. At the center of its length, this thermal conducting plate can be provided with at pressing section Which is pushed towards the battery, and with spring structures continuous with the thermal conducting plate and positioned on, both sides of the pressing section. Further, the thermal conducting plate can be provided with a mounting cavity in the pressing section to hold a temperature sensor, and a temperature sensor can be disposed in that mounting cavity. The pressing section can be shaped to follow the contour of a circular cylindrical battery.

The battery charger described above has the characteristic that battery temperature can be measured to, high precision via a temperature sensor, and temperature can be accurately detected while reducing time delays. This is because the battery charger described above is provided with thermal conducting units which press against surfaces of batteries loaded in the battery pocket of the case, and the thermal conducting units have thermal conducting plates and temperature sensors. In particular, since the battery charger of the present invention is configured to elastically press thermal conducting units against battery surfaces via spring structures, thermal conducting plates are pressed in intimate contact with the batteries, and battery heat can be effectively transmitted to temperature sensors via the thermal conducting plates. Consequently, in the battery charger described above, battery heat can be effectively transmitted to temperature sensors via thermal conducting plates, battery temperature can be detected with high precision and little time delay, and batteries can be charged under ideal temperature conditions.

Further, in a battery charger which installs a, temperature sensor between a battery and a thermal conducting plate, the temperature sensor can be disposed with the temperature detection region of the battery covered by the thermal conducting plate in this configuration transmitted heat and temperature sensors do not come in contact with air and are not cooled by air contact, and since heat generated by the batteries can be transmitted to the entire periphery of the temperature sensors by the thermal conducting plates, battery temperature can be accurately as well as rapidly detected.

### BRIEF DESCRIPTION OF THE DRAWINGS

FIG. 1 is an abbreviated cross-section view showing battery temperature detection in a structure investigated by the present patent applicant.

FIG. 2 is an abbreviated cross-section view showing battery temperature detection in another structure investigated by the present patent applicant.

FIG. 3 is a cross-section view showing the battery temperature detection region of another related art battery charger

FIG. 4 is an abbreviated cross-section view showing battery temperature detection with the temperature sensor of the battery charger shown in FIG. 3.

FIG. 5 is an oblique view of a battery charger of an embodiment of the present invention.

FIG. 6 is an oblique rear view showing the battery charger shown in FIG. 5 loaded with a AA type battery.

FIG. 7 is an oblique view showing the battery charger shown in FIG. 5 with its rotating output terminals in the up position.

FIG. 8 is a plan view showing AAA type batteries loaded in the, battery charger shown in FIG. 7.

FIG. 9 is a side view of the battery charger shown in FIG. 8.

FIG. 10 is an enlarged cross-section view showing batteries loaded in the battery charger shown in FIGS.

FIG. 11 is an oblique view showing the battery charges shown in FIG. 7 with its upper case removed.

FIG. 12 is an exploded oblique view of a thermal conducting unit of the battery charger shown in FIG. 11.

FIG. 13 is a cross-section view showing the positional relation of a battery and a thermal conducting unit.

FIG. 14 is an enlarged cross-section view showing a battery charger of an embodiment of the present invention detecting battery temperature with a temperature sensor.

FIG. 15 is a circuit diagram, showing one example of a charging circuit in a battery charger of an embodiment of the present invention.

FIG. 16 is graph showing temperature characteristics and voltage characteristics during battery charging for a battery charger of an embodiment of the present invention.

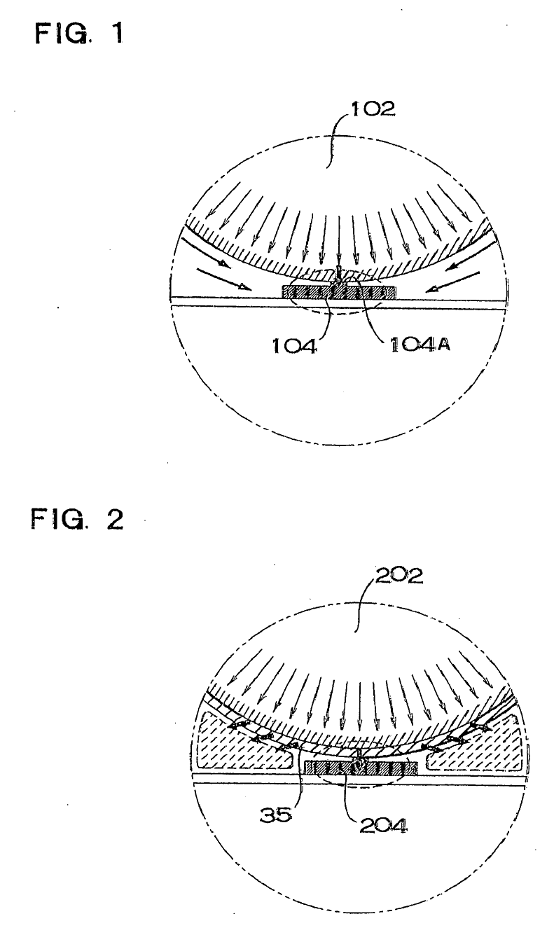

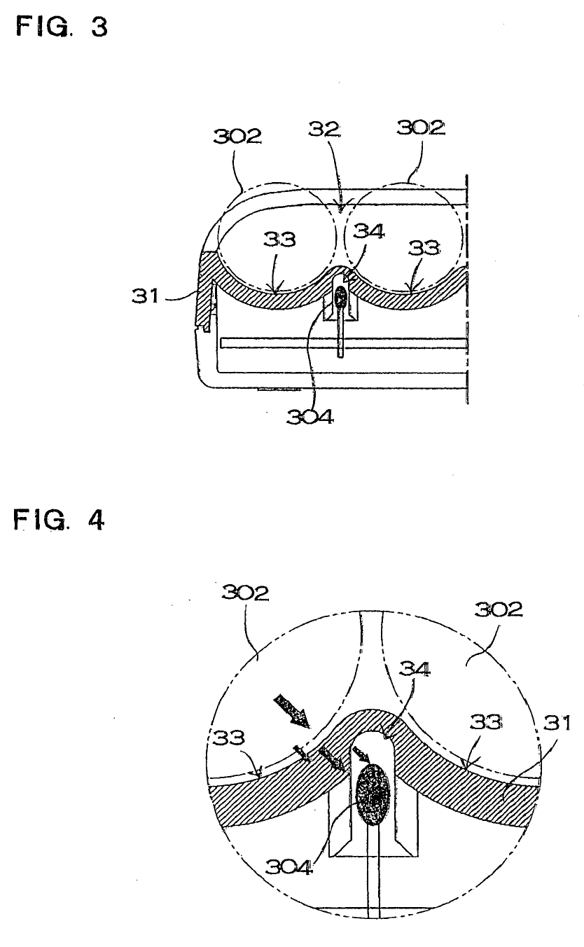

### DETAILED DESCRIPTION OF THE INVENTION

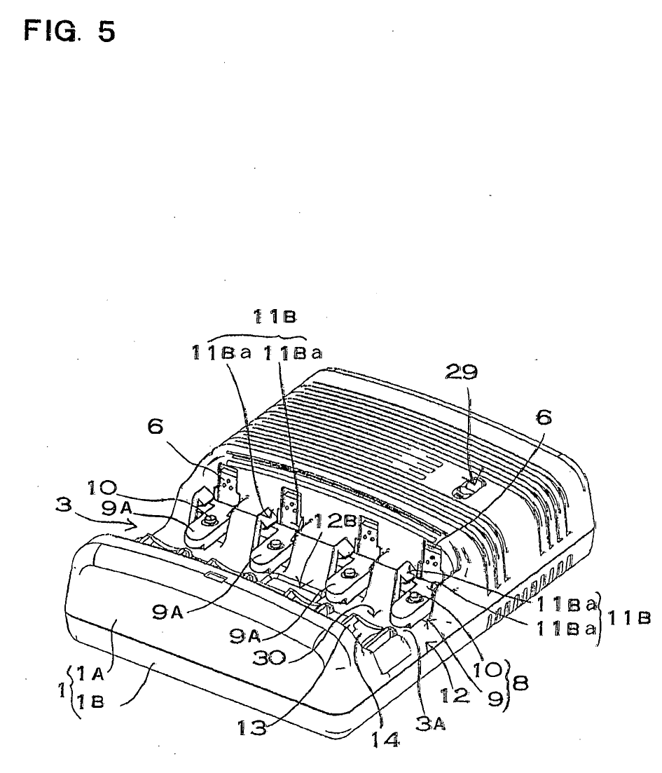

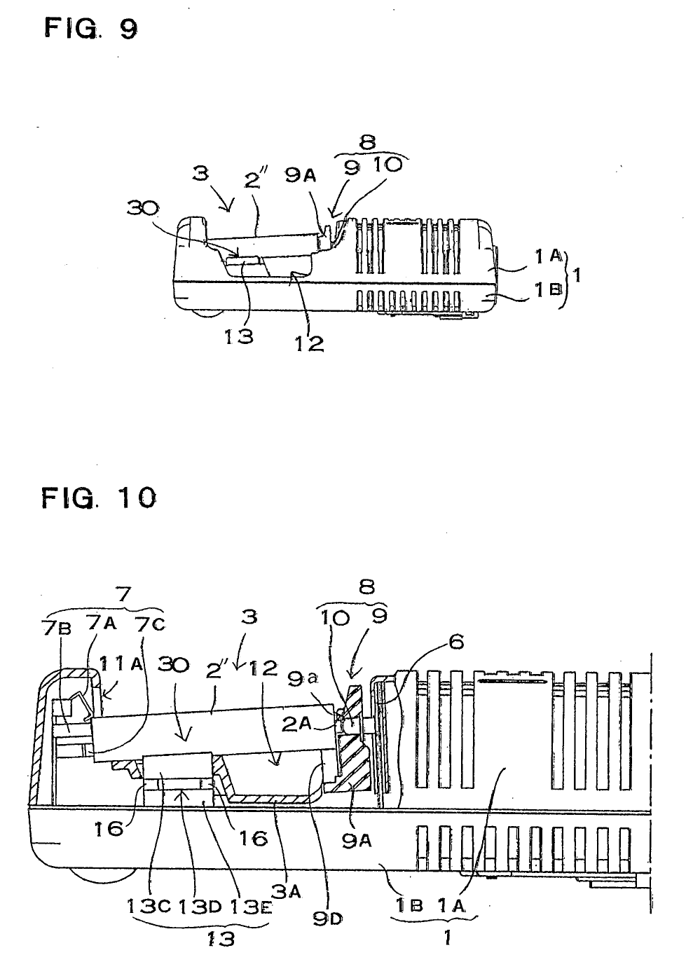

The battery charger shown in FIGS. 5-12 has an approximately rectangular box outline, and has a battery pocket 3, allowing batteries 2 to be loaded and unloaded for charging. The battery pocket 3 is provided in the upper surface of a case 1, which is the lower part of the plan view of FIG. 8 Thermal conducting units 30 are disposed in the battery pocket 3 to press against the surfaces of batteries 2 loaded in the battery pocket 3. Thee thermal conducting units 30 are provided with thermal conducting plates 13 housing temperature sensors 4 which detect the temperature of each of four corresponding batteries 2 loaded for charging. Further, a charging circuit (not illustrated) mounted on a circuit board 5 in the case 1 enables, the battery charger to detect battery temperature with the temperature sensors 4 and control average charging current to the batteries 2.

The case 1 has a lower case 1B and an upper case 1A, and the upper case 1A is joined to the lower case 1B to house the circuit board 5 inside. The circuit board 5 is attached to the lower case 1B. Output terminals, 6, 7, which connect with terminals of batteries 2 loaded in the battery pocket 3, are fixed to the circuit board 5. The output terminals 6, 7 are metal plates which can elastically deform. Since four batteries 2 are loaded for charging in the battery charger of the figures, four pairs of output terminals 6, 7 are provided.

In addition, the battery charger of the figures can charge both AA and AAA type batteries 2′, 2″. These AA and AA type single cell rechargeable batteries are long, slender, and have approximately a circular cylindrical shape. In particular, the surface of the metal can of these batteries 2 is covered with a resin tube except for the positive and negative terminals at both ends.

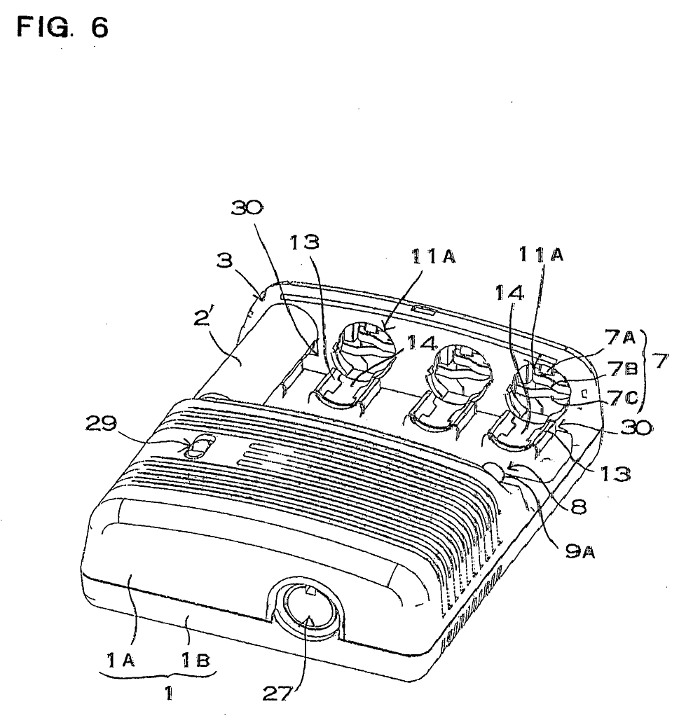

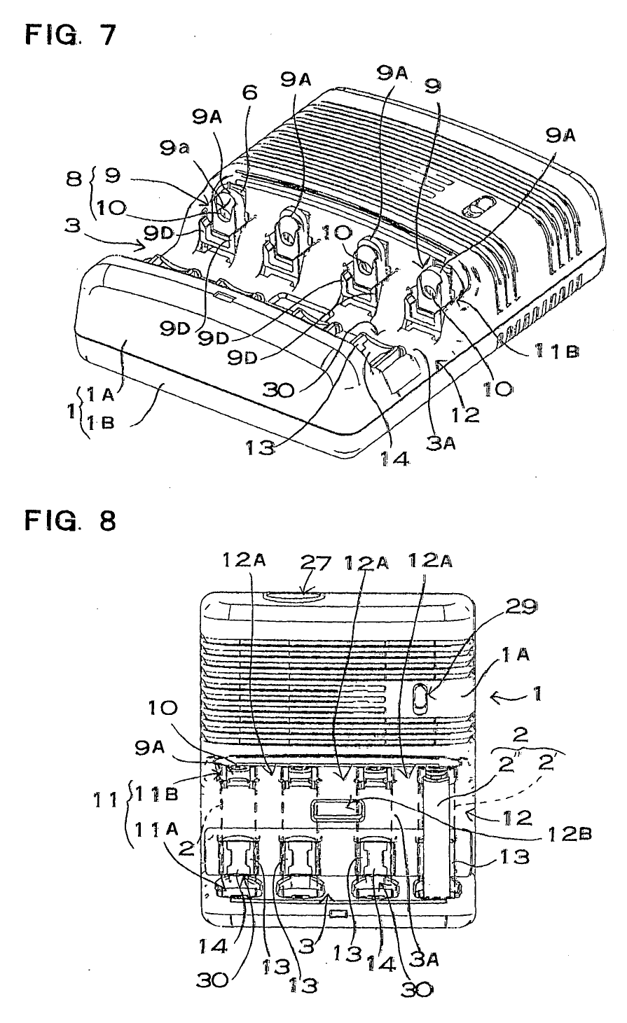

First, when charging AA type batteries 2′, the positive terminal ends of the batteries 2′ are put in contact with output, terminals 6 with the rotating output terminals 8 in the down position, as shown in FIGS. 5 and 6. The negative terminal ends of the batteries 2′ are put in contacts with, output terminals 7. Then, when charging AAA type batteries 2″, batteries 2″ are loaded and charged with the rotating output terminals 8 in the up, or vertical position, as shown in FIGS. 7-10. In this case, as shown in FIG. 10, four metal extension terminals 10 in the rotating output terminals 8 fill the gaps in front of AA battery output terminals 6 resulting in a configuration which allows output terminals 6 and 7 to be used, with AAA batteries 2″, which are shorter than AA batteries.

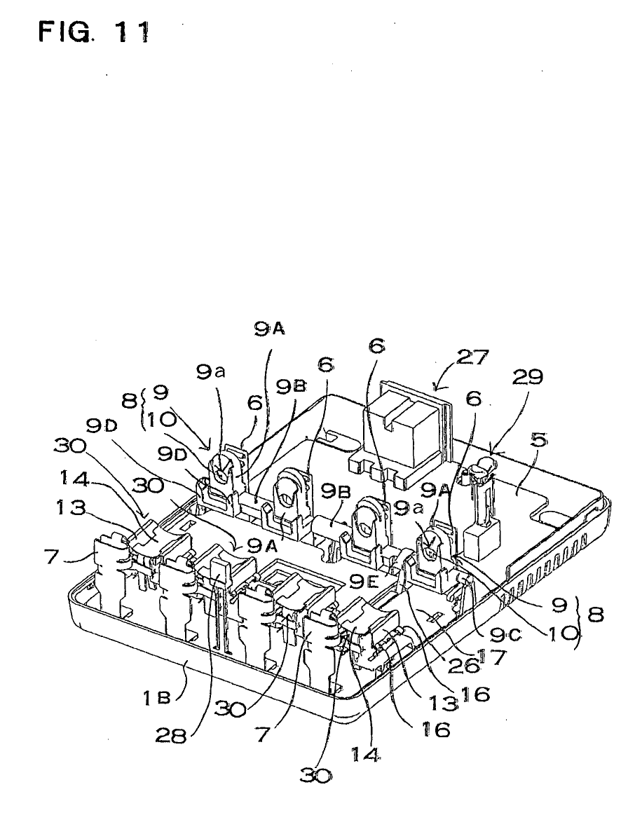

The rotating output terminals 8 have a plastic support unit 9. When four AAA batteries are loaded, the plastic support unit 9 intervenes between output terminals. 6 and protruding positive terminals 2A of the AM batteries 2″. The four metal extension terminals 10, which contact both the output terminals 6 and positive battery terminals 2A, are fixed to the plastic support unit 9. The plastic support unit 9 is provided with four approximately flat-plate insulating base regions 9A which hold each extension terminal 10, and connecting regions 9B which join those base, regions 9A. The periphery of each extension terminal 10 is retained by a plastic, insulating base region 9A, which holds that extension terminal 10 in place. The rotating output terminals 8 of the figures are provided with four cavities 9a in the base regions 9A that allow insertion of the protruding positive terminals 2A of AAA batteries 2″. The extension terminals 10 are disposed passing through, the base regions 9A at the bottoms of those cavities 9a allowing the extension terminals 10 to make contact with the protruding positive terminals 2A of AAA batteries 2″. Pivot regions. 9C provided at both ends of the plastic support unit 9 connect to the case 1 or the circuit board 5 to allow the flat-surface insulating base regions 9A to rotate from horizontal to vertical. In addition, when the plastic support unit 9 is rotated to the vertical position as shown in FIGS. 7 and 11, there are oblique battery holders 9D in the form of truncated V's to hold the bottom sides of AAA batteries 2″.

FIGS. 8-11 show charging of AAA type batteries 2″. In this configuration, rotating output terminals 8 are rotated up putting insulating base regions 9A in the vertical position and disposing them in front of AA battery output terminals, 6. When insulating base regions 9A are rotated to vertical, extension terminals 10 are connected with the charging circuit (not illustrated) for AAA type batteries. When charging AAA type batteries 2″, a switch activation piece 9E, formed as a, unit with connecting regions 9B of the rotating output terminals 8, presses an electrical switch 26 mounted on the circuit board 5 to connect the charging circuit for AAA type batteries. When insulating base regions 9A are dropped to horizontal for charging AA type batteries 2′, pressure on the switch 26 is relieved by rotation of the switch activation piece 9E, and the charging circuit for AA type batteries is connected. As discussed later, this type of battery charger controls average charging current to maintain battery temperature at a holding temperature and charge batteries in a short time.

When charging AA type batteries 2′, insulating base regions 9A of the rotating output terminals 8 are dropped to the horizontal position moving therein down from in front of the AA battery 2′ output terminals 6. Insulating base regions 9A, which have been moved to these positions, do not interfere with the loading of AA type batteries 2′ in the battery pocket 3. Said differently, insulating base regions 91A are moved to positions where they do not hinder AA battery loading in the battery pocket 3. In this configuration, when AA batteries 2′ are loaded in the battery pocket, the AA batteries connect with output terminals 6 fixed to the circuit board 5. Output terminals 6 are connected with a charging circuit (not illustrated) and AA type batteries 2′ are charged.

The case 1 shown in the figures is provided with pairs of battery holders 11. First battery holders 11A and second battery holders 11B intake up the battery holders 11, which retain Long slender circular cylindrical batteries 2 in a manner that keeps both ends of the batteries 2 from shifting position. The first battery holders 11A are circular openings through the case 1 walls, which can retain negative terminal ends of batteries 2′ which are inserted in those openings. Since the end regions of circular cylindrical AA type batteries 2′ are inserted in the battery charger of the figures, openings of the first battery holders 11A are made circular. The internal shapes or those battery holders 11 are made slightly larger than the outlines of the end regions of the batteries 2′. Battery holder 11 internal shapes slightly larger than battery 2′ outlines means batteries 2′ can be smoothly inserted, into the battery holders 11, but battery holder shape allows the inserted batteries to be held without shifting position. The second battery holders 11B have oblique sections 11Ba, 11Ba in the form of truncated V's that form trough shapes to support battery 2 cross-sections perpendicular to the lengthwise direction of the loaded batteries 2′. These oblique sections 11Ba, 11Ba retain the bottom sides of positive terminal ends of the batteries 2′, and AA type batteries 2′ inserted in these troughs are held without lateral shifting. Although battery holders 11 in the battery pocket 3 of the figures have one end formed to allow battery end insertion, both ends may also be formed as openings to allow insertion and retention of battery end regions. Further, both ends of the battery holders may also be shaped to avoid lateral shifting.

In the case of AAA type batteries 2″ loaded in the battery, charger, batteries 2″ are held in the configuration shown in FIG. 10. In detail, each negative output terminal 7 is made up of three metal contract pieces 7A, 7B, 7C. When AA type batteries 2′ are loaded, all contact pieces 7A, 7B, 7C make contact with the circular negative battery 2′ terminals. When AAA type batteries 2″ are loaded, negative output terminal 7 contact pieces 7B, 7C make contact with the circular negative battery 2 terminals, while upper contact pieces 7A, which have inverted rectangular C-shaped cross-sections, press down on the upper ends of the circular negative battery terminals to hold them in place. Positive terminal ends of AAA batteries 2″ are held from below by oblique battery holders 9D when insulating base regions 9A of the rotating output terminals 8 are in the vertical position.

Cooling gaps 12 are provided in the battery pocket 3 of the figures between the first battery holders 11A and the second battery holders 11B. The cooling gaps 12 form air cooling ducts between the bottom 3A of the battery pocket 3 and the batteries 2. Air passing through these cooling ducts cools batteries 2 being charged. Consequently, a battery charger provided with, cooling gaps 12 as shown in the figures, has the characteristic that batteries can be charged to full charge in a short time while keeping battery temperatures low. In addition, to sufficiently cool the batteries 2, a through hole 12B, which passes through the battery charger with an approximately rectangular shape as viewed from the upper surface, is provided in the bottom 3A of the battery pocket 3

Further, the first battery holders 11A and the second battery holders 11B are disposed to form gaps 12A (refer to FIG. 8) between adjacent batteries 2 in the battery pocket 3 of the battery charger of the figures. For batteries 2 loaded in this battery pocket 3, cooling ducts allow air to pass through cooling gaps 12 between the case 1 and the batteries 2, and gaps 12A allow cooling air to pass between adjacent batteries 2 as well. Consequently, a battery charger having a battery pocket 3 of this configuration has the characteristic that the loaded batteries 2 can be effectively cooled, and charging can be performed while reducing battery temperature increase. In FIG. 8, the battery 2 positioned at the rights side is a AAA type battery 2″, and the outlines of the wider AA type batteries 2′ are shown with broken lines.

Next, the thermal conducting units 30, which are characteristic of the present invention, are described in detail. Four thermal conducting units 30, which press against the circular cylindrical surface of each battery 2 loaded in the battery pocket 3, are disposed in the battery pocket 3. The part of a thermal conducting unit 30 that presses against a battery 2 is shaped to follow the circular cylindrical contour of the battery 2, and although contact with the battery surface is desirable from a heat conduction perspective a slight gap is acceptable. In the battery charger of the figures, each thermal conducting unit 30 is provided with a thermal conducting plate 13, a temperature sensor 4, and spring structures 16 formed as a unit with the thermal conducting plate 13 to elastically press the thermal conducting unit 30 against the battery surface.

In the battery charger of the figures, thermal conducting plates 13 are disposed close to the first battery holders 11A. Since thermal conducting plates 13 are disposed close to battery holder 11 openings in which battery 2 end regions are inserted, upward shift in position of the batteries 2 can be effectively prevented even when being pushed upward by the thermal conducting plates 13. Therefore, In this configuration of battery charger thermal conducting plates 13 can press solidly against battery 2 surfaces, and battery temperature can be detected more accurately

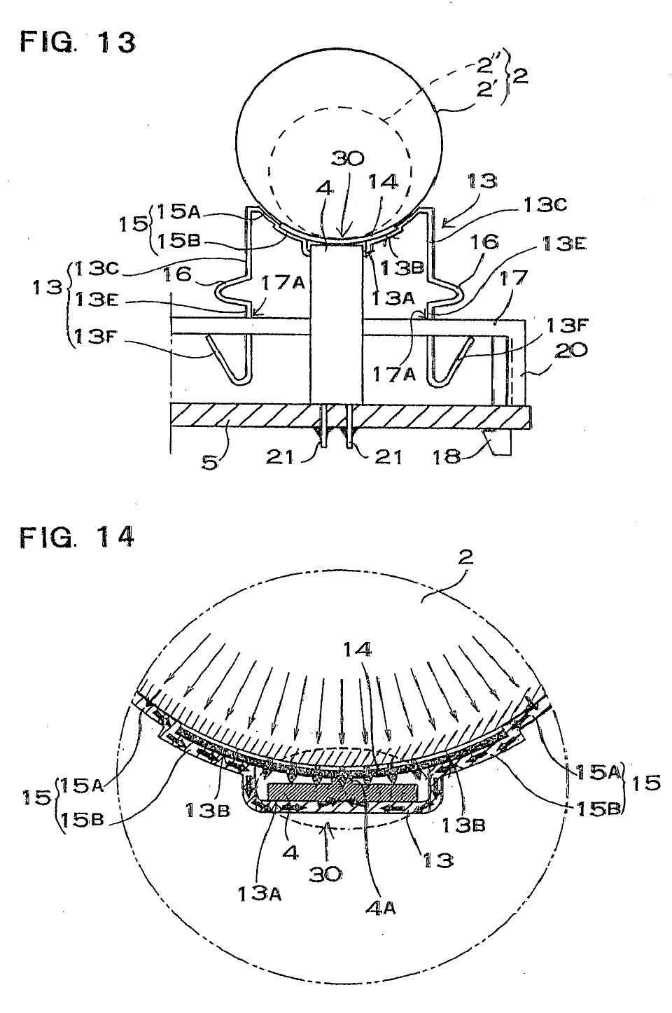

The four thermal conducting plates 13 have approximately the same shape. As shown in the cross-section view of FIG. 13, each thermal conducting plate 13 is a metal plate with a pressing section 15 curved to follow part of the bottom of the circular cylindrical surface of a battery 2. Each thermal conducting plate 13 has a structure which is approximately symmetrical in the lateral direction relative to the battery 2, which extends in a lengthwise direction. A thermal conducting plate 13 is a, single piece of long narrow metal plate which is suitably cut-out and bent. A thermal conducting plate 13 is provided with a pressing section 15 at the center of the lengthwise direction of the metal plate, two leg sections 13C which, bend down from both sides of the pressing section 15, and spring structures 16 which are positioned in adjacent pairs at the sides of the bottom) of each leg section 13C having U-shaped cross-sections to give them resilient flexibility. Cut-outs 13E are located between spring structures 16, 16 on each, leg section 13C. Leg section end regions 13E are located below the spring structures 16, 16, and retaining tabs 13F, which are narrower than the end regions 13E, extend below the end regions 13E. Both retaining tabs, 13F pass through slats 17A in a base plate 17, are bent back putting the ends of the retaining tabs 13F in contact with the bottom surface of the base plate 17, and thereby holding the thermal conducting plate 13 on the base plate 17.

A protective sheet 14 is fixed to the surface of each thermal conducting plate 13. A protective sheet 14 is a pliable insulating sheet, for example, plastic sheet. A protective sheet 14 provides insulation between a temperature sensor 4 and battery 2, and prevents temperature sensors 4 from directly contacting a battery surface. Namely, protective sheets 14 protect the, temperature sensors 4. In the thermal conducting plates 13 of the figures, protective sheets 14 are fixed to the center regions of the thermal conducting plates 13. A protective sheet 14 is fixed to the entire center region except to side regions adjacent to leg sections 13C. The protective sheets 14 have dog-bone shapes oriented with the lengthwise direction of the dog-bones aligned with the lengthwise direction of the batteries. Protective sheets 14 can be easily attached via. an adhesive layer. However, protective sheets 14 can also, be attached via bond or glue.

In the battery charger of the figures, a recessed region 13B, which is lower by an amount equivalent to the thickness of a protective sheet 14, is established in the protective sheet 14 attachment area of each thermal conducting plate 13. The purpose of the recessed region 13B is to put both the metal plate of the thermal conducting plate 13 and the protective sheet 14 in contact with the battery surface. When a protective sheet 14 is fixed inside a recessed region 13B, the surface of the protective sheet 14 and the metal plate surface of the thermal conducting plate 13, which lies outside the area of protective sheet 14, contact the surface of the battery 2.

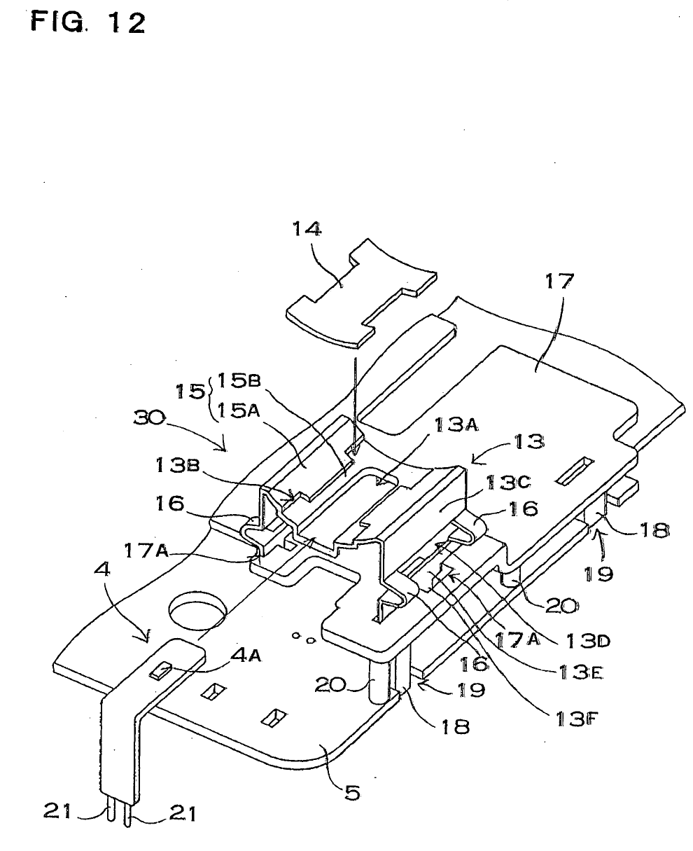

In addition, each thermal conducting plate 13 is provided with a mounting cavity 13A in its pressing section 15 to house a temperature sensor 4. Each temperature sensor 4 is disposed in a mounting cavity 13A and its surface is covered with a protective sheet 14. Consequently, each mounting cavity 13A is disposed within a recessed region 13B A film-type temperature sensor 4 is fixed to the upper surface of each mounting cavity 13A Thermistors are used as temperature sensors 4, but temperature sensors other than thermistors can also be used. Film type temperature sensors 4 are generally sold as off-the-shelf items, and as shown in FIG. 14, they have an approximately rectangular temperature detection, section 4A which, projects with some thickness above the upper surface of a film substrate. Each mounting cavity 13A is trough shaped wish a width that can accept and affix a film-type temperature sensor 4. Specifically, a mounting cavity 13A has a width slightly wider than a temperature sensor 4. As shown in FIG. 12, at temperature sensor 4 is inserted in a mounting cavity 13A and fixed to the thermal conducting plate 13. In the pressing section 15 of the thermal conducting plate 13 shown in the figures, the mounting cavity 13A does not extend to lateral edges (leg sections 13G) of the pressing section 15. On FIG. 12, the mounting cavity 13A extends to the lower left edge of the pressing section 15, but not to the upper right edge. A temperature sensor 4 is fixed in a mounting cavity 13A, which extends to one edge, and the temperature sensor 4 and its connections extend outside the thermal conducting plate 13.

A pressing section 15, which presses against the surface of a battery is established at the top of each thermal conducting plate 13 A pressing section 15 is made up of a direct pressing section 15A, which directly presses metal plate regions of the thermal conducting plate 13 against a battery surface, and an indirect pressing section 15B, which presses the thermal conducting plate 13 against a battery surface via the protective sheet 14 and temperature detection section 4A. In each thermal conducting plate 13 of the figures, direct pressing section 15A is established laterally outside both sides of the indirect pressing section 15E. In a thermal conducting plate 13, battery 2 heat is conducted primarily along the following parts, as indicated by the arrows of FIG. 14. Battery 2 heat its transferred to the temperature sensor 4 primarily by paths (4) and (5) below.

(1) thermal conduction in the battery itself

(2) thermal conduction from the battery 2 to the direct pressing section 15A

(3) thermal conduction in the thermal conducting plate 13 (frown the indirect pressing section 15B to the direct pressing section 15A)

(4) thermal conduction in the thermal conducting plate 13 from the indirect pressing section 15B to the temperature sensor 4)

(5) thermal conduction from the battery 2 to the protective sheet 14 to the temperature sensor 4

In a battery charger, which conducts heat from AA type batteries 2′ to temperature sensors 4 via the paths listed above, there are few thermal conduction paths from the batteries 2′ to the temperature sensors 4. Further, the temperature sensors 4 do not come in contact with, nor are they cooled by air. Still further, air does not flow into any gaps between thermal conducting plates. 13, and batteries 2′ to the cool thermal conducting plates 13. As a result, battery 2′ heat is effectively transferred to thermal conducting plates 13 Consequently, there are few conducting paths from batteries 2′ to temperature sensors 4, transferred heat and temperature sensors 4 are not cooled by air and AA type battery temperature can be accurately detected with high precision and reduced time delay.

When AAA type batteries 2″ are located in the battery charger, batteries 2″ contact thermal conducting units 30 as shown by the broken line in FIG. 13. Thermal conducting units 30 contact battery 2′ surfaces in the case of AA type batteries 2′. In the case of AAA type batteries with smaller circular cylinder radius, thermal conducting units 30 contact the bottom section of the batteries 2″

In a thermal conducting plate as described above, direct pressing section 15A is disposed laterally on both sides of an, indirect pressing section 15B. However, direct pressing section may also be disposed on three sides of an indirect pressing section, or surrounding the entire perimeter of an indirect pressing section 15B. In a thermal conducting plate 13 as shown in the figures, an indirect pressing section 15B is disposed inside direct pressing section 15A. This configuration allows battery 2 heat transferred to the direct pressing section 15A to be effectively transferred from both sides to the indirect pressing section 15B.

To put the thermal conducting plates 13 in contact with battery surfaces without forming gaps, thermal conducting plates 13 are elastically pressed against battery surfaces via spring structures 16. The thermal conducting plates 13 of the figures are metal plates which can elastically deform. In a thermal conducting plate 13 which is a metal plate with elasticity, spring structures 16 are configured as a single piece of metal plate. The thermal conducting plates 13 of the figures have spring structures 16 connected on both sides. Spring structures 16 are bent in U-shapes making them easy to elastically deform. Further, as shown in FIG. 12, spring structures 16 are made narrower than the thermal conducting plate 13 also making them easy to elastically deform. In the thermal conducting plates 13 of the figures, spring structures 16 are connected on both sides of a thermal conducting plate 13. A thermal conducting plate 13 with spring structures 16 connected on both sides can apply balanced pressure to the surface of a battery 2 over the entire pressing area of the thermal conducting plate 13. A thermal conducting plate, as shown in the figures, has two columns of spring structures 16 connected on each side, but a single spring structure 16 may also be connected on each side. In addition, a thermal conducting plate may also have spring structure(s). connected on only one side.

The battery charger of the figures has a base plate 17 fixed to the surface of the circuit board 5, and thermal conducting plates 13 are fixed to this base plate 17 via spring structures 16. The base plate 17 is an insulating material such as plastic. The base plate 17 has a laterally symmetric structure, and is provided with connecting hooks 18 formed as a single piece with the base plate 17 at both sides as shown in FIGS. 12 and 13 (only the right side is shown in FIGS. 12 and 13). The ends of these connecting hooks 18 latch on the backside of the circuit board 5 to connect the base plate 17. The circuit board 5 is provided with connecting cavities 19 to accept the connecting hooks 18. The base plate 17 is joined to the circuit board 5 by inserting connecting hooks 18 into the connecting cavities 19. Connecting hooks 18 inserted in connecting cavities 19 flexibly grip the circuit board 5 ad both sides, and the ends of thee connecting hooks 18 latch on the backside of the circuit board 5 to attach the base plate 17 to the circuit board 5. In addition, the base plate 17 has a plurality of standoff projections 20, formed as a single piece with, the base plate 17, and protruding from the circuit board side of the base plate 17. The ends of the standoff projections 20 contact the circuit board 5, and maintain a constant standoff distance between the base plate 17 and the circuit board 5. A base plate 17 of this structure can easily be connected to the circuit board 5 to keep a constant standoff gap between the two. Further, the base plate 17 is joined to the circuit board 5 while passing the leads 21 of temperature sensors 4 fixed to thermal conducting plates 13.

A configuration which does not connect spring structures 16 directly to the circuit board 5, but rather connects them to an intervening base plate 17, has the effect of improving the accuracy of battery temperature detection by the temperature sensors 4. This is because heat from thermal conducting plates 13 is not directly transferred to the circuit board 5. In this configuration, direct transfer of heat from, the thermal conducting plates 13 to the circuit board 5 is blocked by the base plate 17. For the purpose of accurate battery temperature detection by the temperature sensors 4, it is best to reduce heat radiation from the thermal conducting plates 13. If the thermal conducting plates 13 radiate heat in large quantities, battery 2 heat will radiate away via the thermal conducting plates 13, thermal conducting plate 13 temperature will drop, and the temperature detected by temperature sensors, 4 attached, to the thermal conducting plates 13 %Will drop. The base plate 17 can, reduce heat radiation from, thermal conducting plates 13 more than the circuit board 5. This is because the base plate 17 is smaller than the circuit board 5 and has a worse heat transfer coefficient. Since there is no need to mount various electronic parts on the base plate 17, it can be smaller than the circuit board 5. Further, unlike the circuit board 5, there is no need for the base plate 17 to have layers of metal interconnects, which are excellent heat conductors. Finally, since the base plate 17 only touches the circuit board 5 locally at standoff projections 20 and connecting hooks 18, heat transfer from the base plate 17 to the circuit board can be minimized. If heat is transferred from thermal conducting plates 13 to the base plate 17 and then efficiently transferred from the base plate 17 to the circuit board 5, indirect cooling of the thermal conducting plates 13 via the base plate 17 will result. However, if base plate 17 heat is not effectively conducted to the circuit board 5 the base plate 17 will not cool the thermal conducting plates 13. Unnecessary heat radiation from the thermal conducting plates 13 is prevented by a base plate 17 which does not cool the thermal conducting plates 13, and temperature sensors 4 attached to those thermal conducting plates 13 accurately detect battery temperature.

Further, direct heating of the circuit board 5 by high battery temperature can be effectively prevented in a configuration that connects thermal conducting plates 13 to a base plate 17. To control charging current to the batteries 2, a semiconductor switching device such as a power transistor or power field effect transistor (FET) is mounted on the circuit board 5. Since the semiconductor switching device is heated by battery charging current, the efficiency of its cooling is important. This is because as the temperature of the switching device increases, the amount of current it can tolerate decreases. In a configuration which does not directly heat the circuit board 5 with the thermal conducting plates 13, circuit board 5 temperature can be kept low, the temperature of the semiconductor switching device such as a power FET cain be kept low, and the allowable current can be increased. In addition, thermal runaway and failure of the semiconductor switching device can be reduced.

The battery charger of the present embodiment has a socket 27 for connection of an external power cord (refer to, FIGS. 6 and 11) a light emitting diode (LED) 28 which lights during charging (refer to) FIG. 11), and a switch 29 which sets a timer with the charging time.

The charging circuit detects battery temperature via. the temperature sensors 4, control average charging current to, keep battery temperature at a holding temperature, and charges batteries while maintaining battery temperature at the holding temperature. This battery charger has the characteristic that batteries 2 can be charged in an extremely short time.

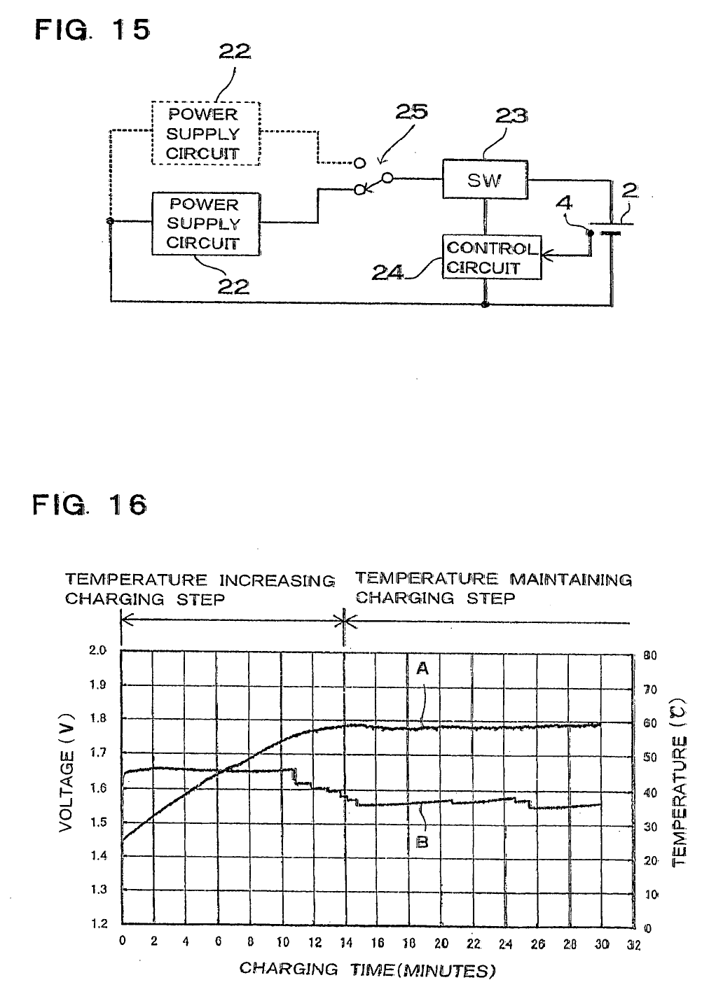

FIG. 15 shows the charging circuit This charging circuit is provided with a power supply circuit 22 to supply charging current to charge the battery 2, a switching device 23 connected between the power supply circuit 22 and the battery 2 to regulate average charging current to the battery 2, a control circuit 24 to control charging current by switching the switching device 23 on and off, and a temperature sensor 4 to detect battery temperature and input a temperature signal to the control circuit 24. Here although FIG. 15 shows one battery 2, and the discussion refers to a battery 2 in the singular, it should be clear that a plurality of batteries 2 can also be charged according to the same battery charger and charging circuit.

The graph of FIG. 16 shows battery temperature rise and battery voltage variation characteristics when a battery 2 is charged with the charging circuit of FIG. 15. In FIG. 16, curve A is the battery temperature rise characteristic curve, and curve B is the battery voltage variation characteristic curve. As shown in FIG. 16, the charging circuit of FIG. 15 does not reduce the rate of battery temperature rise at full charge, but rather raises battery temperature to a specified temperature at the commencement of charging in a temperature increasing charging step, and subsequently charges while maintaining battery temperature at a holding temperature in a temperature maintaining charging step. Consequently, high current is forced at the beginning of charging and battery temperature is raised. In other words, the battery 2 is charged with a current large enough to raise the battery temperature. Although the battery 2 is charged by high current at this time, no battery performance degradation occurs because battery temperatures does not immediately become high. Therefore, the battery 2 can be charged to high capacity during this time.

With the switching device 23 in the ON state, the power supply circuit 22 is capable of high current output to charge a battery 2 with an average of 1.5 C to 10 C, preferably 2 C to 8 C, and still more preferably 2C to 5C. The power supply circuit can be configured as a separate unit and connected to the control circuit via extension leads. However, the power supply circuit and control circuit can also be housed in the same case.

As shown in FIG. 15, the charging circuit can also switch between a plurality of power supply circuits 22 to charge a battery 2′. The, plurality of power supply circuits 22 are connected to the switching device 23 via a switch 25. The switch 25 switches to select the power supply circuit 22 for battery 2 charging. The plurality of power supply circuits 22 have, different peak currents during pulse charging. Even if average battery charging currents are the same, battery 2 heat generation will increase with high peak current during pulse charging. Therefore, if the power supply circuit 22 is switched to, a lower peak current supply when the battery 2 is charged with high current, battery 2 heat generation can be reduced. Consequently, battery temperature rise can be reduced while charging with a higher average current.

The switching device 23 is a bipolar transistor or FET which is switched by the control circuit 24 to pulse charge a battery 2. The switching device 23 is held in the ON state without switching to initially charge the battery 2 with high current until battery temperature rises to a specified temperature and holding temperature. In this case, charging is constant current charging The switching device 23 can also be switched ON and OFF at a prescribed duty factor to initially charge the battery 2 with pulsed high current (high average current) until battery temperature rises to the specified temperature and holding temperature.

Average charging current for pulse charging a battery, 2 is regulated by the duty factor for switching the switching device 23 ON and OFF. The duty factor (Q) for pulse charging is a ratio of the time the switching device 23 is ON (ton) and the time the switching device 23 is OFF (toff), and is given by the following formula.
Q=ton/(ton+toff)
Consequently, as the duty factor for switching the switching device. 23, ON and OFF is decreased, average charging current decreases, and conversely as the duty factor is increased, average charging current increases

The control circuit 24 detects battery temperature from a signal input from the temperature sensor 4, and switches the switching device 23 ON and OFF at a prescribed duty factor. The duty factor for switching the switching device 23 ON and OFF is small for high battery temperature, and is increased as battery temperature drops to maintain battery temperature at the holding temperature. As shown in FIG. 16, since battery temperature is initially low at the beginning of charging, the battery 2 is charged with high current until battery temperature reaches a specified temperature. Subsequently, the control circuit 24 controls the duty factor of the switching device 23 to maintain battery temperature at a holding temperature. The control circuit 24 switches the switching device 23 ON and OFF with a period of 1 msec to 10 sec, preferably 10 msec to 2 sec, and still more preferably 50 msec to 2 sec.

When temperature detected by the temperature sensor 4 is lower than the holding temperature, the control circuit 24 increases the duty factor to increase the average pulse charging current and raise battery 2 temperature. When battery temperature rises to the holding temperature, the control circuit 24 controls the switching device 23 by reducing the duty factor to, prevent battery temperature from exceeding the holding temperature. Further, the control circuit 24 controls the switching device 23 duty factor to prevent battery temperature from dropping below the holding temperature. Consequently, the control circuit 24 charges the battery 2 neither by constant current charging nor by constant voltage charging. The control circuit 24 controls the switching device 23 duty factor to regulate average charging current and control battery 2 temperature to behave as shown by curve A of FIG. 16.

The charging circuit of FIG. 15 charges a battery 2 by the following steps. Although the following is an example of a nickel hydrogen battery charging method, a nickel cadmium battery can also be charged in the same manner by changing the charging current.

(1) First, prior to beginning charging the temperature sensor 4 in the charging circuit detects the temperature of the battery to be charged. When the detected battery temperature is within the specified range for commencing charging, the temperature increasing charging step is initiated. The specified temperature range for commencing charging with the temperature increasing charging step, is 0° C. to 40° C., and preferably 10° C. to 30° C. When battery temperature is below or above the specified range for commencing charging, ordinary charging is initiated while detecting battery voltage. Ordinary charging controls charging current for charging at or below 11C while monitoring battery voltage, and full charge is determined when battery voltage reaches a peak or drops a ΔV from that peak.

Further, remaining capacity of the battery 2 is, determined from battery voltage. This is done because if a battery near full charge is charged according to the temperature increasing charging step, over-charging will occur and battery performance will degrade. A batter with voltage below a prescribed battery voltage is judged to have low remaining capacity, and charging is started according to the temperature increasing charging step. A battery with voltage higher than the prescribed battery voltage is judged to have high remaining capacity with the likelihood of over-charging if charged by the temperature increasing charging step. Therefore, ordinary charging is started for a battery with voltage higher than the prescribed battery voltage

In addition, internal resistance of the battery 2 its detected at the start of charging. When internal resistance is higher than a prescribed resistance, no transition to the temperature increasing charging step is made and ordinary charging is performed. If internal resistance becomes smaller than the prescribed resistance after ordinary charging, the temperature increasing charging step may be started as well.

(2) In the case of battery 2 temperature within the specified range for commencing charging and battery voltage lower than the prescribed battery voltage, the temperature increasing charging step Isis started. In the, temperature increasing charging step, the battery 2 is, charged with a high current which raises battery temperature at a specified rate. In this step, the battery 2 is charged with an average current, that makes battery temperature rise at a rate of about 3° C./minute. In the case of an AA type nickel hydrogen battery with a, nominal capacity of 2100 mAh, the rate of temperature rise becomes 3° C./minute with an average charging current for 2 C to 3 C. However, in this step, the battery 2 can be charged with an, average charging current that makes the rate of temperature rise 1° C./minute to 5° C./minute. Further, the average charging current may charge at 1.5 C to 10 C as well in this step, the switching device 23 is maintained in the ON state, or the duty factor of the switching device 23 is large to make the average charging current within the previously mentioned range. When battery temperature rises to the specified temperature and approaches the holding temperature, average charging current is decreased to reduce the rate of battery 2 temperature rise, For example, if the holding temperature is approximately 57° C. to 60° C. and the rising specified temperature (for example, approximately 55° C.) is detected, average charging current is decreased to reduce the rate of battery 2 temperature rise.

In, FIG. 16, when battery temperature rises, to the rising specified temperature of approximately 55° C., that temperature is detected, and average charging current is reduced to mellow the rate of temperature rise and approach the holding temperature (curve A, temperature increasing charging step at about 11 minutes of charging time in FIG. 16). Average charging current is controlled by reducing the ON-OFF duty factor of the switching device 23. In this type of charging method which reduces average charging current when battery 2 temperature approaches the holding temperature and reaches the rising specified temperature, overshoot or the holding temperature is prevented, and battery 2 degradation due to the negative effects of high temperature can be effectively prevented. However, the battery 2 may also be charged with an average charging current which, maintains the specified rate of temperature rise until the holding temperature is reached.

(3) When battery temperature rises to the holding temperature at the end of the temperature increasing charging step, average charging current is regulated to maintain battery temperature at the holding temperature for charging according to the temperature maintaining charging step. In this temperature maintaining charging step, the control circuit 24 controls the ON-OFF duty factor of the switching device 23 to regulate the average current for pulse charging and maintain battery temperature at the holding temperature. In this step, the temperature sensor 4 detects battery temperature and inputs a temperature signal to the control circuit 24. The control circuit. 24 controls the ON-OFF duty factor of the switching device 23 based on the detected battery temperature. When battery temperature becomes high, the duty factor is reduced, average charging current is decreased, and battery temperature is lowered. When battery temperature becomes low, the duty factor is increased, average charging current is increased, and battery temperature is raised. In this fashion, charging is performed while maintaining battery temperature at the holding temperature. In the temperature maintaining charging step, it is desirable to hold battery temperature at a single temperature (for example, 58° C.).

Here, the holding temperature is set near a maximum temperature, which is below the temperature that results in performance degradation and negative effects on the battery. In addition, the holding temperature is set to a temperature at which the user has no problem touching the battery 2 and does not feel that it is abnormally hot. For this level of holding temperature, the maximum is set about 70° C., preferably 65° C. or less, and more preferably 63° C. or less. As a holding temperature range, 50° C. to 65° C. is preferable, 53° C. to 63° C. is more preferable, and 56° C. to 61° C. and 57° C. to 60° C. are even more preferable.

To maintain battery temperature at the holding temperature in the present embodiment, temperature is controlled as follows. First, a specified control temperature (for example, 58° C.) is set for the holding temperature. For example, for every 1° C. that the detected battery temperature is above the specified control temperature, average charging current is reduced in stages like step by step. Similarly, for every 1° C. that the detected battery temperature is below the specified control temperature, average charging current is increased in stages like step by step. By this type of control, charging is performed while maintaining battery temperature at the holding temperature.

In place of the specified control temperature described above, a specified control temperature range (for example, 57° C. to 59° C. may be set. For example, for every 1° C. that the detected battery temperature is above the specified control temperature range, average charging current is reduced in stages like step by step. Similarly, for every 1° C. that the detected battery temperature is below the specified control temperature range, average charging current is increased in stages like step by step. Again, by this type of control, charging is performed while maintaining battery temperature at the holding temperature.

In this temperature maintaining charging step, when the battery 2 nears full charge, the tendency for battery temperature to rise becomes stronger even though, average charging current is reduced. Consequently, as the battery 2 nears full charge, battery temperature rises or tries to rise, but average charging current decreases to maintain the holding temperature. Specifically, the control circuit 24 controls the ON-OFF duty factor of the switching device 23 to an extremely small value. As a result, the control circuit 24 abruptly decreases the average charging current as the battery 2, nears full charge. Consequently, in the temperature maintaining charging step, even if full battery charge is not detected and charging is not suspended, average charging current is rapidly reduced and over-charging is prevented. In the temperature maintaining charging step of the present embodiment charging is terminated by a timer. The timer is set to a time period (for example, approximately 30 minutes) that will sufficiently charge the battery 2 to approximately full charge. In the present embodiment, since battery temperature rises and average charging current decreases near full charge as described above, charging is terminated by detecting this decrease in current, even if it is prior to timer expiration.

Further, when charging the battery by the temperature maintaining charging step, internal resistance of the battery 2 is detected. When battery 2 internal resistance becomes greater than a specified value, ordinary/charging is performed and charging current is reduced. Even in ordinary charging, battery 2 temperature is kept from becoming higher than the holding temperature.

(4) By the temperature increasing charging step and temperature maintaining charging step above, the battery 2 is essentially fully charged. However, the battery 2 does not completely reach full charge. Ordinary charging can be performed after the temperature maintaining charging step, to fully charge the battery 2 to completion.

In the charging method described above, a battery 2 is pulse charged, during a temperature increasing charging step and temperature maintaining charging step. However, it is not always a requirement to adjust average charging current by controlling the pulse charging duty cycle. For example, in the temperature increasing and temperature maintaining charging steps, charging current for continuous charging can also be controlled, and the battery can be charged by a specified current as the average charging current.

The charging circuit described above charges by controlling average charging current to maintain battery temperature at a specified temperature.

However, the charging circuit may also charge the battery 2 with constant current, and terminate charging when peak battery voltage is detected or when a ΔV drop from that peak voltage is detected. This charging circuit suspends or interrupts charging when battery temperature rises above a set temperature, and keeps battery temperature from exceeding a set temperature.

As this invention may be embodied in several forms without departing from the spirit or the essential characteristics thereof, the present embodiment is therefore illustrative and not restrictive, since the scope of the invention is defined by the appended claims rather than by the description preceding them, and all changes that fall within the metes and bounds of the claims or equivalence of such metes and bounds thereof are therefore intended to be embraced by the claims.

This application is based on application No. 2003-3062161 filed in Japan on Aug. 29, 2003, the content of which is incorporated into by reference.

1. A battery charger comprising a case having a battery pocket in which battery can be loaded and unloaded, temperature sensor which detect the temperature of the battery loaded in the battery pocket, and a charging circuit in which battery temperature is detected by the temperature sensor and charging current is controlled;
wherein the battery charger is provided with a thermal conducting unit which pressed against the surfaces of the battery loaded in the battery pocket, and a spring structure which elastically press the thermal conducting unit against the battery surface;
and wherein the thermal conducting unit has a thermal conducting plate and the temperature sensor.

2. A. battery charger as recited in claim 1 wherein the battery is a circular cylindrical single cell battery, and the section of the thermal conducting unit which presses against the battery is shaped to follow the circular cylindrical contour of the battery.

3. A battery charger as recited in claim 1 wherein the battery pocket in the case is provided with a pair of batter holders comprising a first battery holder and a second battery holder to hold both ends of the circular cylindrical battery and keep it from shifting position.

4. A battery charger as recited in claim 3 wherein the first battery holder is a circular shaped opening.

5. A battery charger as recited in, claim 3 wherein the thermal conducting plate is disposed in close proximity to the battery holder.

6. A battery charger as recited in claim 1 wherein a cooling gap is provided which forms a battery cooling duct between the bottom of the battery pocket and the battery.

7. A battery charger as recited in claim 1 wherein the temperature sensor is disposed between the battery and the thermal conducting plate.

8. A battery charger as recited in claim 7 wherein a protective sheet is attached to the surface of the thermal conducting plate, the protective sheet is a insulating sheet, and the protective sheet provides insulation between the temperature sensor and the battery.

9. A battery charger as recited in claim 8 wherein the thermal conducting plate has recessed region, which is lower by an a mount equivalent to the thickness of the protective sheet.

10. A battery charger as recited in claim 8 wherein the thermal conducting plate is provided with a mounting cavity to house the temperature sensor the temperature sensor is disposed in the mounting cavity, and its surface is covered with the protective sheet.

11. A battery charger as recited in claim 1 wherein a spring structure is connected to a circuit board via, a base plate.

12. A battery charger as recited in claim 1 wherein the thermal conducting plate is a single long narrow strip of metal plate which can deform elastically and which is bent, and the spring structure is formed as a single unit with the thermal conducting plate.

13. A battery charger as recited in claim 12 wherein the thermal conducting plate is provided with a pressing section which apply pressure to the battery and spring structures which are continuous with both sides of the pressing section.

14. A battery charger as recited in claim 13 wherein the mounting cavity to, house the temperature sensor is provided in the pressing section of the thermal conducting plate, and the temperature sensor is disposed in the mounting cavity.

15. A battery charger as recited in claim 13 wherein the pressing section is shaped to follow the contour of the circular cylindrical battery shape.

16. A battery charger as recited in claim 1 wherein the charging circuit controls average charging current to cause battery temperature to become a specified holding temperature, and the battery is charged while maintaining battery temperature at the holding temperature.

17. A battery charger as recited in claim 16 wherein average charging current is controlled by switching a switching device ON, and OFF IQ control the duty factor.
